(19) United States
(12) Patent Application Publication
(10) Pub. No.: US 2023/0313398 A1
(43) Pub. Date: Oct. 5, 2023

(54) SYSTEM AND METHOD FOR CONTROLLING OPERATIONS OF ELECTROLYZERS BASED ON REACTIVE POWER

(71) Applicant: Ohmium International, Inc., Incline Village, NV (US)

(72) Inventors: Rasool Aghatehrani, Redwood City, CA (US); Arne Ballantine, Lugano (CH); Chockkalingam Karuppaiah, Incline Village, NV (US)

(21) Appl. No.: 18/130,817

(22) Filed: Apr. 4, 2023

Related U.S. Application Data
(60) Provisional application No. 63/326,944, filed on Apr. 4, 2022.

(51) Int. Cl. C25B 15/023; C25B 1/04; C25B 1/50

(52) U.S. Cl. CPC C25B 15/023; C25B 1/04; C25B 1/50

(57) ABSTRACT

Systems and techniques are described herein. For instance, a method for producing hydrogen is described. The method includes determining an amount of reactive power for an electrolyzer of a hydrogen-production installation connected to a power grid to generate, or to consume; and controlling operations of the electrolyzer such that electrolyzer generates, or consumes, substantially the determined amount of reactive power. Additionally, a system for producing hydrogen is described. The system includes a connection to a power grid configured to receive electrical power from the power grid; one or more electrolyzers configured to receive the electrical power and to produce hydrogen; and a controller configured to: determine an amount of reactive power for the one or more electrolyzers to generate, or to consume; and control respective operations of the one or more electrolyzers such that the one or more electrolyzers collectively generate, or consume, substantially the determined amount of reactive power.

### CROSS-REFERENCE TO RELATED APPLICATIONS

This application claims priority to U.S. Provisional Application No. 63/326,944 entitled “Electrolyzer-Based Reactive Power Compensation”, filed Apr. 4, 2022, the entire contents of which are incorporated by reference herein.

### FIELD

The present disclosure relates to systems and methods for controlling operations of an electrolyzer based on reactive power. For example, some embodiments of the present disclosure relate to controlling hydrogen-production of electrolyzers and/or operations of power electronics of electrolyzers to balance reactive power.

### BACKGROUND

A power grid may supply electrical power, in the form of alternating electrical current (AC), to a number of devices (e.g., at a number of industrial and/or residential sites). Systems or devices connected to the power grid may include resistive elements and reactive elements. Reactive elements include capacitive elements and inductive elements. Capacitive elements (e.g., banks of capacitors) may cause voltage of an AC power signal to lag behind current of the AC power signal (e.g., by storing energy in an electric field). Inductive elements (e.g., reactors) may cause current of the AC power signal to lag behind voltage of the AC power signal (e.g., by storing energy in a magnetic field).

In the present disclosure, the term “apparent power” may refer to the product of a root-mean squared measure of a voltage at a point and a corresponding root-mean-squared measure of current at a point. In the present disclosure, the term “real power” may refer to the portion of instantaneous power that, averaged over a complete cycle of the AC waveform, results in net transfer of energy in one direction. Real power may be described in terms of watts (W). In the present disclosure, the term “reactive power” may refer to the portion of instantaneous power that results in no net transfer of energy, but instead oscillates between the source and load in each cycle due to stored energy in the reactive elements. Reactive power may be described in terms of volt-amperes reactive (var). In the present disclosure, the term “power factor” may refer to the ratio between real power and apparent power.

In the present disclosure, the term “generating reactive power,” and like terms, may refer to delaying a voltage signal relative to a current signal. A capacitive element (e.g., a bank of capacitors) may generate reactive power. In some cases, a load (e.g., a capacitive load) may generate reactive power to cause the voltage signal for a plurality of capacitive loads and inductive loads to be more in phase with the current signal, i.e., decreasing a total amount of reactive power in a system.

In the present disclosure, the term “consuming reactive power,” and like terms, may refer to delaying a current signal relative to a voltage signal. An inductive element (e.g., a reactor) may consume reactive power. In some cases, a load (e.g., an inductive load) may consume reactive power causing the current signal to be delayed relative to the voltage signal.

A load, a power source, or system of loads and/or power sources, that, in aggregate, does not substantially generate or consume reactive power may be referred to as “balanced.” Some systems of loads and/or power sources may include elements (e.g., capacitor banks) for the purpose of balancing the reactive power of the systems. Such a system of loads and/or power sources, may have a power factor of about 1.0. The more reactive power a load, power source, or system of loads, and/or power sources consumes or generates, the further from 1.0 the power factor of such a load, power source or system of loads, may be. In the present disclosure, the term “balance reactive power,” and like terms, may refer to adding additional elements to, removing elements from, or adjusting operations of a load, power source, or system of loads and/or power sources, to cause the load, power source, or system of loads and/or power sources, to be more balanced.

Consuming or generating reactive power (that exceeds certain thresholds) by power consumers may be undesirable on a power grid. Power-producing, grid operating and/or power-distributing entities, which may be referred to herein as “utilities,” may penalize power consumers for reactive power consumption or generation that exceeds certain thresholds caused by the power consumers. Thus, it may be desirable for power consumers to balance their reactive power generation and consumption, e.g., to have near net-zero reactive power generation and consumption.

### BRIEF SUMMARY

In some examples, systems and techniques are described for producing hydrogen. According to at least one example, a method is provided for producing hydrogen. The method includes determining an amount of reactive power for an electrolyzer of a hydrogen-production installation connected to a power grid to generate, or to consume; and controlling operations of the electrolyzer such that electrolyzer generates, or consumes, substantially the determined amount of reactive power.

In another example, an apparatus for producing hydrogen is provided that includes at least one memory and at least one processor coupled to the at least one memory. The at least one processor is configured to: determine an amount of reactive power for an electrolyzer of a hydrogen-production installation connected to a power grid to generate, or to consume; and control operations of the electrolyzer such that electrolyzer generates, or consumes, substantially the determined amount of reactive power.

In another example, a non-transitory computer-readable medium is provided that has stored thereon instructions that, when executed by one or more processors, cause the one or more processors to: determine an amount of reactive power for an electrolyzer of a hydrogen-production installation connected to a power grid to generate, or to consume; and control operations of the electrolyzer such that electrolyzer generates, or consumes, substantially the determined amount of reactive power.

In another example, an apparatus for producing hydrogen is provided. The apparatus includes means for determining an amount of reactive power for an electrolyzer of a hydrogen-production installation connected to a power grid to generate, or to consume; and means for controlling operations of the electrolyzer such that electrolyzer generates, or consumes, substantially the determined amount of reactive power.

In another example, a system for producing hydrogen is provided. The system includes a connection to a power grid configured to receive electrical power from the power grid; one or more electrolyzers configured to receive the electrical power and to produce hydrogen; and a controller configured to: determine an amount of reactive power for the one or more electrolyzers to generate, or to consume; and control respective operations of the one or more electrolyzers such that the one or more electrolyzers collectively generate, or consume, substantially the determined amount of reactive power.

In another example, an electrolyzer for producing hydrogen is provided. The electrolyzer includes a hydrogen-production stack configured to receive direct current (DC) power and water to produce hydrogen; power electronics configured to receive alternating current (AC) power, convert the AC power into the DC power, and to provide the DC power to the hydrogen-production stack; and a controller configured to receive a control signal and to control operations of the electrolyzer such that the electrolyzer generates, or consumes, reactive power according to instructions of the control signal.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating a system for controlling production of hydrogen by one or more electrolyzers, e.g., to balance reactive power.

FIG. 2 is a block diagram illustrating an electrolyzer which may be used to balance reactive power.

FIG. 3 is a block diagram illustrating power electronics of an electrolyzer which may be used to balance reactive power.

FIG. 4 illustrates an example of a process for controlling hydrogen production based on reactive power.

FIG. 5 illustrates an example of another process for controlling hydrogen production based on reactive power.

FIG. 6 illustrates an example of another process for controlling hydrogen production based on reactive power.

FIG. 7 illustrates an example computing-device architecture of an example computing device which can implement the various techniques described herein.

### DETAILED DESCRIPTION

An electrolyzer is a device that may use electrical power, in the form of direct electrical current (DC), to drive a chemical reaction. In the present disclosure, the term “electrolyzer” may refer to a device that may produce hydrogen by applying a DC current to water to separate hydrogen from oxygen.

The present disclosure describes systems, apparatuses, methods (also referred to herein as processes), and computer-readable media (collectively referred to as “systems and techniques”) for controlling operations of one or more electrolyzers (e.g., hydrogen-production operations and/or operations of respective power electronics of the one or more electrolyzers) based on reactive power. For example, systems and techniques may control operations of one or more electrolyzers (e.g., hydrogen-production operations and/or operations of respective power electronics of the one or more electrolyzers) to balance reactive power at a hydrogen-production installation.

As an example, a hydrogen-production installation may include one or more electrolyzers that may produce hydrogen. Systems and techniques may control operations of the one or more electrolyzers (e.g., hydrogen-production operations and/or operations of respective power electronics of the one or more electrolyzers) to balance reactive power of the hydrogen-production installation.

Additionally, or alternatively, the hydrogen-production installation may include, or be collocated with one or more loads, and/or one or more power sources. The systems and techniques may control operations of the one or more electrolyzers of the hydrogen-production installation (e.g., hydrogen-production operations and/or operations of respective power electronics of the one or more electrolyzers) to balance reactive power of the one or more loads, and/or one or more power sources.

By balancing reactive power at the hydrogen-production installation, systems and techniques may improve operations of the hydrogen-production installation, at least by decreasing reactive power and conserving real power. Further, by balancing reactive power at the hydrogen-production installation, systems and techniques may prevent, or decrease, fees from utilities based on an imbalance of reactive power at the hydrogen-production installation. Additionally, or alternatively, the systems and techniques may alleviate, or reduce, the need for hydrogen-production installations to include other reactive-power compensators, which may result in significant reduction of costs. Additionally, or alternatively, the systems and techniques may create additional revenue for hydrogen-production installations through providing the additional reactive-power support to the AC system or the AC grid.

Various examples of the systems and techniques are described herein and will be discussed below with respect to the figures.

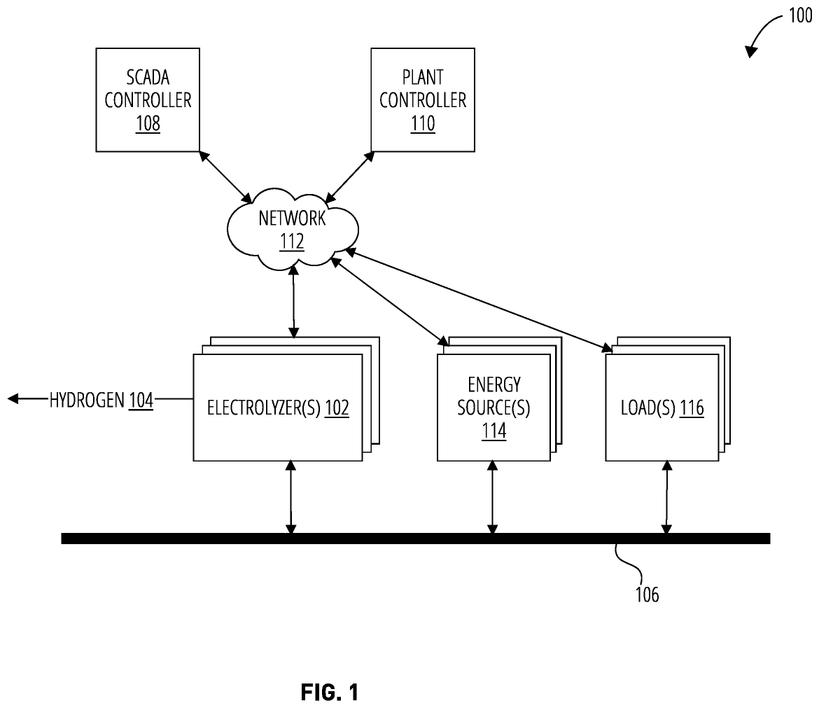

FIG. 1 is a block diagram illustrating a system 100 for controlling production of hydrogen 104 by one or more electrolyzers 102, e.g., to balance reactive power. System 100 may be a hydrogen-production installation including electrolyzers 102.

System 100 includes supervisory control and data (SCADA) controller 108. SCADA controller 108 may monitor and control operations within system 100 (e.g., start up, shut down, restart of electrolyzers 102).

System 100 includes plant controller 110, which may receive commands (e.g., from an operator) and control operations within system 100 responsive to the commands. Plant controller 110 may coordinate the operation of electrolyzers 102 to cause commands to be executed appropriately. Control loops of plant controller 110 could be open-loop or closed-loop. For the closed-loop controls, plant controller 110 may continuously monitor feedback signals and adjust commands sent to the electrolyzers 102 accordingly.

Energy sources 114 are optional in system 100. For example, in some embodiments, one or more energy sources 114 may be included in system 100. Additionally, or alternatively, one or more energy sources 114 may be collocated with system 100. Additionally, or alternatively, one or more energy sources 114 may be separate from and remote from system 100; yet system 100 may interact with energy source 114 based on a connection to a common power grid. In other embodiments, system 100 does not include or interact with energy sources 114.

Energy sources 114 may be, or may include, one or more energy storage systems and/or one or more energy production systems. As examples, energy sources 114 may include energy sources based on solar energy, wind energy, geothermal energy, biomass energy, hydropower energy, nuclear energy, internal combustion, gas turbines, steam turbines.

Loads 116 are similarly optional in system 100. For example, in some embodiments, one or more loads 116 may be included in system 100. Additionally, or alternatively, one or more loads 116 may be collocated with system 100. Additionally, or alternatively, one or more loads 116 may be separate from and remote from system 100; yet system 100 may interact with loads 116 based on a connection to a common power grid. In other embodiments, system 100 does not include or interact with loads 116.

System 100 may include network 112, which may be any suitable network (e.g., an Ethernet network) for communicatively connecting SCADA controller 108, plant controller 110, electrolyzer 102, energy sources 114, and/or loads 116.

Electrolyzers 102, energy sources 114, and/or loads 116 may be connected to a power grid at grid connection 106. Grid connection 106 may be, or may include, electrical distribution system. Grid connection 106 may be included in the hydrogen-production installation or grid connection 106 may be, at least partially, external to the hydrogen-production installation. Any or all of electrolyzers 102, energy sources 114, and/or loads 116 may affect a voltage signal and/or a current signal of the power grid based on their respective usage or and/provision of electrical energy. Further, any or all of electrolyzers 102, energy sources 114, and/or loads 116 may consume or generate reactive power affecting the power grid.

System 100 (e.g., using SCADA controller 108 and/or plant controller 110) may control operations of electrolyzers 102 (e.g., hydrogen-production operations and/or operations of respective power electronics of the one or more electrolyzers) to balance the reactive power of system 100 (whether system 100 includes energy sources 114 and/or loads 116 or not). Additionally, or alternatively, system 100 may control operations of electrolyzer 102 (e.g., hydrogen-production operations and/or operations of respective power electronics of the one or more electrolyzers) to balance reactive power of energy sources 114 and/or loads 116, e.g., in cases in which energy sources 114 and/or loads 116 are not part of system 100 but are collocated with system 100 and/or in cases in which energy sources 114 and/or loads 116 are remote from system 100 but interact with system 100.

Electrolyzers 102 may be, or may include, any suitable electrolyzers, such as, for example, one or more proton exchange membrane (PEM) electrolyzers, one or more alkaline electrolyzers, solid-oxide electrolyzers, and/or one or more anion exchange membrane (AEM) electrolyzers. Electrolyzers 102 may additionally include power electronics, a cooling system, a hydrogen-purification system, a water-purification system, and/or an uninterruptible power supply. Electrolyzers 102 may receive electrical power (e.g., AC current) from grid connection 106 and water (not illustrated in FIG. 1). Using power electronics, electrolyzers 102 may convert the AC current to DC current and produce hydrogen 104 using the DC current and the water.

Electrolyzers 102 (or more specifically, the power electronics of electrolyzers 102) (individually and collectively) may be capable of generating reactive power or consuming reactive power. For example, by controlling operations of power electronics of an electrolyzer 102 (e.g., an AC voltage level within the electrolyzer 102), the electrolyzer 102 can be caused to exhibit either capacitive or inductive properties. In some cases, the power electronics may include one or more reactive-power compensation devices (e.g., capacitor banks, synchronous condensers, thyristor-controlled reactors (TCR), thyristor-switched capacitors (TSC), static var compensators (SVC), and/or static synchronous compensators (StatComs)). Thus, operations of the electrolyzer 102 (e.g., operations of the power electronics of electrolyzer 102) can be controlled to generate or consume reactive power, e.g., by delaying a voltage signal or a current signal of AC current provided to the electrolyzer 102. Thus, system 100, by controlling electrolyzers 102, may be capable of balancing reactive power without the need for system 100 to include additional reactive-power compensation devices (e.g., capacitor banks, synchronous condensers, TCRs, TSCs, SVCs, and/or StatComs) in system 100.

Hydrogen 104 produced at electrolyzers 102 may be output to, as examples, one or more compressors, one or more hydrogen storage tanks, and/or one or more pipelines. Production of hydrogen 104 by system 100 may, or may not, be directly tied to demand. For example, system 100 may vary a rate at which hydrogen 104 is produced independent of a rate at which hydrogen 104 is consumed. Thus, unlike utilities, which may generate electricity according to demand, system 100 may determine a rate at which to produce hydrogen 104 based on factors other than demand (e.g., based on reactive power).

Electrolyzers 102 may produce hydrogen 104 at a number of different rates. The rate at which electrolyzers 102 produce hydrogen 104 may govern an amount of electrical power electrolyzers 102 consume. Further, the amount of electrical power electrolyzers 102 consume may be related to how much reactive power power electronics of the electrolyzers 102 can consume or generate. Reactive power generation of consumption by electrolyzer 102 will take a portion of power electronics capacity. The power electronics may have additional capacity to support the rated active power and rated reactive power at full loading. If the power electronics is not enough to support the rated active power and rated reactive power at full loading, the electrolyzer controller may prioritize the rated active power over the reactive power or may prioritize the rated reactive power over the rated active power based on what the system operator may select.

For example, an electrolyzer 102 may be capable of consuming a certain amount (e.g., X) of kilovolt-Amperes (kVA). For example, electrolyzer 102 may have nameplate capacity describing how many kVAs electrolyzer 102 can consume according to its specification. At any given time, the maximum amount of real power consumed and the amount of reactive power consumed or generated by the electrolyzer 102 may be constrained by the equation X kVA=\sqrt{(Y kVAR)²+(Z kW)²}, where Y is the amount of reactive power that can be consumed or generated at the give time (where kVAR represents the unit kilovolt-amperes reactive), and Z is the amount of real power consumed at a given time (where kW represents the unit kilowatts). Thus, at any given time, the electrolyzer 102, may decrease the amount of real power consumed (by decreasing a rate of hydrogen production) to allow the power electronics to consume, or generate, more reactive power.

By controlling the power electronics of electrolyzer 102, system 100 (e.g., using SCADA controller 108 and/or plant controller 110) may control whether the electrolyzers 102 (collectively or individually) generate or consume reactive power. By controlling the rate of production of hydrogen 104 by electrolyzer 102, system 100 may increase an amount of reactive power that the power electronics can generate or consume.

As one example, an event may occur that causes a transient effect in a power grid. For example, a load may come online. The load may cause the voltage signal to lag behind the current signal (e.g., the load may generate an amount of reactive power). System 100 (e.g., using SCADA controller 108 and/or plant controller 110) may detect the transient effect. System 100 (e.g., using SCADA controller 108 and/or plant controller 110) may determine that electrolyzers 102 are capable of consuming the reactive power, e.g., compensating for the transient or balancing system 100 and/or balancing reactive power on the power grid more generally. System 100 may control operations of electrolyzers 102 to consume the reactive power.

For example, in some cases, system 100 may determine that electrolyzers 102, using power electronics thereof, are capable of consuming the reactive power. In such cases, system 100 may control electrolyzers 102 (e.g., may control the power electronics of electrolyzers 102) to consume the reactive power. The transient effect may be temporary, e.g., while the load which caused the transient is unsecured. After the transient effect ends (e.g., when the load is secured) system 100 may detect the end of the transient effect and may cease causing electrolyzers 102 to consume reactive power, e.g., returning electrolyzers 102 to pre-transient operations.

As another example, in some cases, system 100 may determine that the power electronics of electrolyzers 102 are not capable of consuming the reactive power based on currently available reactive power capacity of electrolyzers 102 (e.g., based on Y in the equation X kVA={square root over ((Y kVAR)²+(Z kW)²))}. In such cases, system 100 may determine to adjust an amount of hydrogen being produced by one or more of electrolyzers 102 (e.g., decreasing Z in the equation X kVA={square root over ((Y kVAR)²+(Z kW)²))} to give the power electronics of electrolyzers 102 additional capacity to consume reactive power (e.g., decreasing Z to allow Y to increase while Z remains constant). After the transient effect ends, system 100 may detect the end of the transient and may return electrolyzers 102 to pre-transient operations e.g., causing electrolyzers 102 to produce pre-transient levels of hydrogen and causing power electronics of electrolyzers 102 to cease consuming the reactive power.

System 100 (e.g., using SCADA controller 108 and/or plant controller 110) may control operations of electrolyzers 102 (e.g., hydrogen-production operations and/or operations of respective power electronics of the one or more electrolyzers) according to one or more system-level operational criteria, including, e.g., to maintain a constant reactive-power generation or reactive-power consumption, to maintain a constant power factor, or to maintain a voltage level.

When the system-level operational-criteria relates to a constant reactive-power generation or reactive-power consumption, system 100 may control operation of electrolyzers 102 (e.g., hydrogen-production operations and/or operations of respective power electronics of the one or more electrolyzers) such that reactive-power generation or reactive-power consumption at grid connection 106 is maintained, or such that constant reactive-power generation or reactive-power consumption at a remote point in the power grid is maintained. In some cases, system 100 may be configured such that system 100 is capable of providing extra capacity for reactive-power exchange even when electrolyzers 102 are operating at full capacity.

When the system-level operational-criteria relates to a constant power factor, system 100 may control operation of electrolyzers 102 (e.g., hydrogen-production operations and/or operations of respective power electronics of the one or more electrolyzers) such that a power factor at grid connection 106 is maintained, or such that a power factor at a remote point in the power grid is maintained. In some cases, system 100 may be configured such that system 100 is capable of providing extra capacity for reactive-power support even when electrolyzers 102 are operating at full capacity

When the system-level operational-criteria relates to voltage, system 100 may control operation of electrolyzers 102 (e.g., hydrogen-production operations and/or operations of respective power electronics of the one or more electrolyzers) such that a voltage between terminals of one or more of electrolyzers 102, a voltage at grid connection 106 (e.g., between the hydrogen-production installation and the power grid), or a voltage at a remote point in the power grid is held substantially within a threshold. Additionally, or alternatively, system 100 may be configured such that it generates or consumes reactive power only when a voltage between terminals of one or more of electrolyzers 102, a voltage at grid connection 106 (e.g., between the hydrogen-production installation and the power grid), or a voltage at a remote point in the power grid is outside of a specific target voltage range. Additionally, or alternatively, system 100 may be configured such that it adjusts the amount of reactive power generated or consumed based on the deviation of the voltage between terminals of one or more of electrolyzers 102, a voltage at grid connection 106 (e.g., between the hydrogen-production installation and the power grid), or a voltage at a remote point in the power grid from specific target voltage range. For example, electrolyzer 102 may cause electrolyzers 102 to consume more reactive power during over-voltage conditions of the power grid and to generate more reactive power during under-voltage conditions of the power grid. As an example, system 100 may control electrolyzers 102 to keep the voltage within a range, e.g., by adjusting electrolyzers 102 when the voltage exceeds the range to bring the voltage back within the range.

In this way, system 100 may control operation of electrolyzers 102 (e.g., hydrogen-production operations and/or operations of respective power electronics of the one or more electrolyzers) to control generation or consumption of reactive power by electrolyzers 102 to balance reactive power of system 100, energy sources 114, and/or loads 116. System 100 may control operation of electrolyzers 102 to control generation or consumption of reactive power by electrolyzers 102 to resolve a deficiency in a reactive-power capability of system 100, of electrolyzers 102, of energy sources 114, and/or of loads 116. In some cases, system 100 may support the power grid beyond thresholds of utilities to provide additional support to the AC system of the power grid. In some cases, system 100 may enhance the AC-system load-hosting capacity of the power grid. In some cases, system 100 may enhance the AC-system energy-resource-hosting capacity of the power grid. In some cases, system 100 may provide ancillary services to the grid.

Although not illustrated in FIG. 1, in some case, system 100 may include additional reactive-power compensation devices (e.g., capacitor banks, synchronous condensers, TCRs, TSCs, SVCs, and/or StatComs) In other cases, system 100 may not include any such reactive-pose compensation devices. Additionally, or alternatively, although not illustrated in FIG. 1, system 100 may include one or more energy-storage systems. System 100 may compensate for a deficiency in a reactive-power capability of such an energy-storage system.

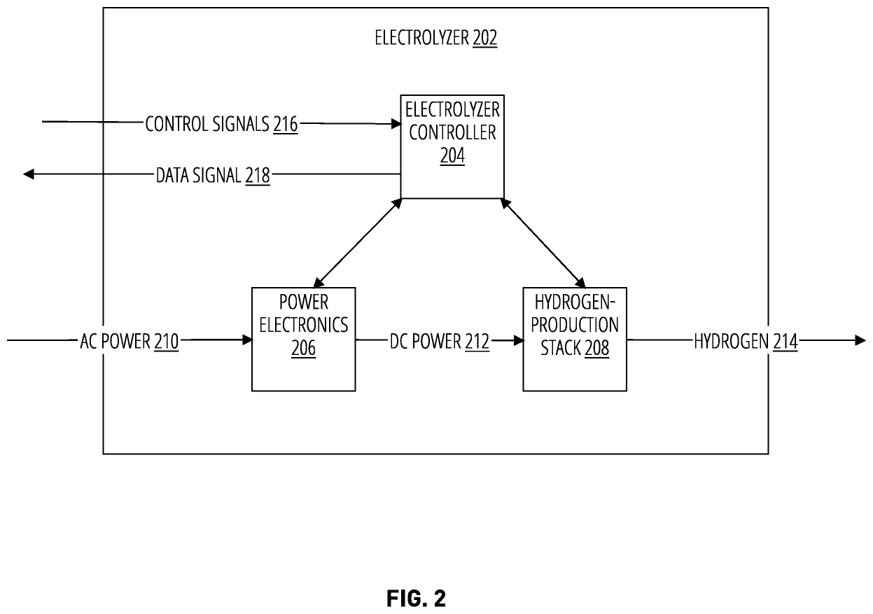

FIG. 2 is a block diagram illustrating an electrolyzer 202 which may be used to consume or generate reactive power, e.g., to balance a system including electrolyzer 202. Electrolyzer 202 may be an example of one of electrolyzers 102 of FIG. 1. Electrolyzer 202 may include an electrolyzer controller 204, a power electronics 206, and a hydrogen-production stack 208.

Power electronics 206 may receive AC power 210, e.g., from a power grid, (e.g., at a grid connection such as, grid connection 106 of FIG. 1). Power electronics 206 may include a pulse-width modifier (PWM) and a rectifier to convert AC power 210 to DC power 212. Power electronics 206 may additionally include a DC-DC converter to adjust DC power 212. Additionally, or alternatively, power electronics 206 may include one or more reactive-power compensation devices (e.g., capacitor banks, synchronous condensers, TCRs, TSCs, SVCs, and/or StatComs).

Power electronics 206 may, according to an AC internal voltage, exhibit capacitive properties (e.g., causing electrolyzer 202 to generate reactive power) or inductive properties (e.g., causing electrolyzer 202 to consume reactive power). Power electronics 206 may adjust the amount of reactive power consumed or generated by adjusting the internal AC voltage of (e.g., based on the control command received from electrolyzer controller 204.)

Power electronics 206 may be able to be change from exhibiting capacitive properties to inductive properties (and vice versa) relatively quickly, e.g., more quickly than other loads. As an example, Power electronics 206 may be able to change from exhibiting capacitive properties to inductive properties (and vice versa) in under a second, e.g., in hundreds of milliseconds.

Power electronics 206 may be used to generate or consume reactive power. For example, power electronics 206 may shift an angle between a voltage signal of AC power 210 and a current signal of AC power 210. For reactive power generation, power electronics 206 may shift an angle between a voltage signal of AC power 210 and a current signal of AC power 210, such that the current signal will be ahead relative to the voltage signal. Alternatively for reactive power consumption, power electronics 206 may shift an angle between a voltage signal of AC power 210 and a current signal of AC power 210, such that the current signal will be delayed relative to the voltage signal. While power electronics 206 are shifting the angle between the voltage signal of AC power 210 and the current signal of AC power 210, power electronics 206 may increase the magnitude of a current signal of AC power 210 to maintain DC power 212 and production of hydrogen 214.

Hydrogen-production stack 208 may include one or more units for performing electrolysis, e.g., for using DC power 212 to drive a chemical reaction to produce hydrogen 214 from water. Hydrogen-production stack 208 may be, or may include, a proton exchange membrane (PEM) electrolyzers, one or more alkaline electrolyzers, solid-oxide electrolyzers, and/or one or more anion exchange membrane (AEM) electrolyzers. Hydrogen-production stack 208 may be able to produce hydrogen 214 at varying rates. A rate at which hydrogen-production stack 208 produces hydrogen 214 may determine an amount of DC power 212 consumed. In cases in which power electronics 206 are unable to consume, or generate, an amount of reactive power indicated by signals 216, electrolyzer controller 204 may determine to adjust hydrogen production at hydrogen-production stack 208 to provide power electronics 206 with additional capacity to adjust the amount of reactive power consumed or generated. For example, returning to the equation X kVA=\sqrt{(Y kVAR)²+(Z kW)²}, electrolyzer controller 204 may determine to decrease Z (the amount of DC power 212 consumed), in to allow Y additional headroom and to increase Y while Z remains constant. Thus, electrolyzer controller 204 may control hydrogen-production operations of hydrogen-production stack 208 to supplement the reactive power consumption or generation capacity of power electronics 206.

Electrolyzer controllers 204 may control operations of power electronics 206 and/or hydrogen-production stack 208 to control generation of or consumption of reactive power. For example, responsive to control signals 216 (which control signals 216 may be received from a controller (such as, for example, SCADA controller 108 of FIG. 1 or plant controller 110 of FIG. 1), electrolyzer controller 204 may control operation of power electronics 206 and/or hydrogen-production stack 208 to cause electrolyzer 202 to consume or generate reactive power.

Electrolyzer controller 204 may control operation of power electronics 206 and/or hydrogen-production stack 208 according to one or more electrolyzer-level operational criteria including, e.g., based on an amount of DC power 212 hydrogen-production stack 208 consumes, or based on an amount of hydrogen 214 hydrogen-production stack 208 generates. Electrolyzer controller 204 may provide data signal 218 to the controller.

In controlling reactive power, electrolyzer controller 204 may use power electronics 206 to provide a quick response, e.g., responsive to sudden changes in reactive power. Additionally, or alternatively, electrolyzer controller 204 may use power electronics 206 to provide a slow response, e.g., responsive to slower or more predictable changes in reactive power. Slower response in changing the rate of reactive production and consumption may be used for coordination between multiple electrolyzer 202 units.

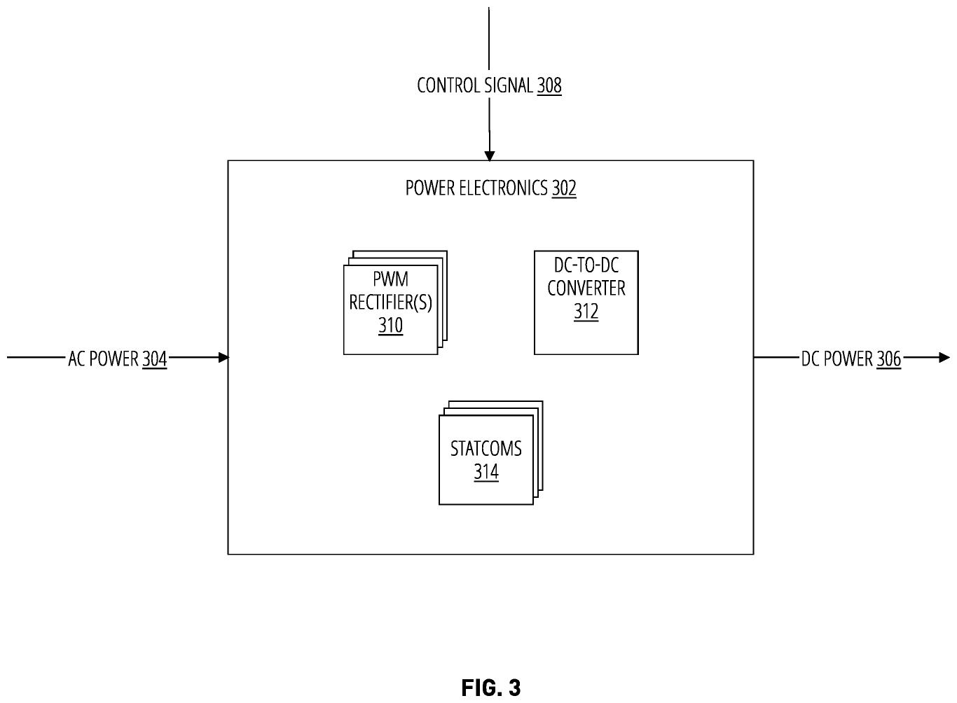

FIG. 3 is a block diagram illustrating power electronics 302 of an electrolyzer which may be used to balance reactive power. Power electronics 302 may be an example of power electronics 206 of FIG. 2. In general, power electronics 302 may receive AC power 304 (e.g., from a grid connection, such as grid connection 106 of FIG. 1) and provide DC power 306 (e.g., to a hydrogen-production stack, such as hydrogen-production stack 208 of FIG. 2). Power electronics 302 may operate according to a control signal 308 (e.g., received from an electrolyzer controller, such as electrolyzer controller 204 of FIG. 2).

Power electronics 302 may include one or more pulse-width modulator (PWM) rectifier(s) 310, which may convert AC power 304 into DC power 306. PWM rectifiers 310 may be configured for high-power operation, e.g., including insulated-gate bipolar transistors (IGBTs).

Further, power electronics 302 may include a DC-to-DC converter 312, which may control a voltage level of DC power 306. DC-to-DC converter 312 may be, for example, a buck converter capable of lowering a voltage of DC power 306, a boost converter capable of increasing a voltage of DC power 306, or a buck/boost converter capable of decreasing or increasing a voltage of DC power 306.

Additionally, or alternatively, PWM rectifier(s) 310 (or power electronics 302) may include one or more reactive-power compensation devices (e.g., capacitor banks, synchronous condensers, TCRs, TSCs, SVCs, and/or StatComs). As an example, power electronics 302 is illustrated including StatComs 314, which may represent one or more reactive-power compensation devices. To control whether power electronics 302 consumes or generates reactive power, an internal AC voltage of inside the power electronics 302 may be set. For example, responsive to control signal 308, the internal AC voltage smaller or larger than the AC power 304 AC voltage signal may be set to cause power electronics 302 to consume or generate reactive power.

PWM rectifier(s) 310 may control the active power applied to the hydrogen-production stack (e.g., hydrogen-production stack 208 of FIG. 2), whereas the StatComs 314 may control the amount of reactive power being consumed or generated. Controlling PWM rectifier(s) 310 may allow the greater control of reactive power via StatComs 314. For example, returning to the equation X kVA=\sqrt{(Y kVAR)²+(Z kW)²}, PWM rectifier(s) 310 may control Z, the amount of real power consumed as a function of time (“kW(t)”). StatComs 314 may control Y, the reactive power consumed, or generated, as a function of kW(t) based on X, the rated kVA of the power converters. Though, Z can be varied without varying kW(t) given that the power converters are not operating at their rated kVA.

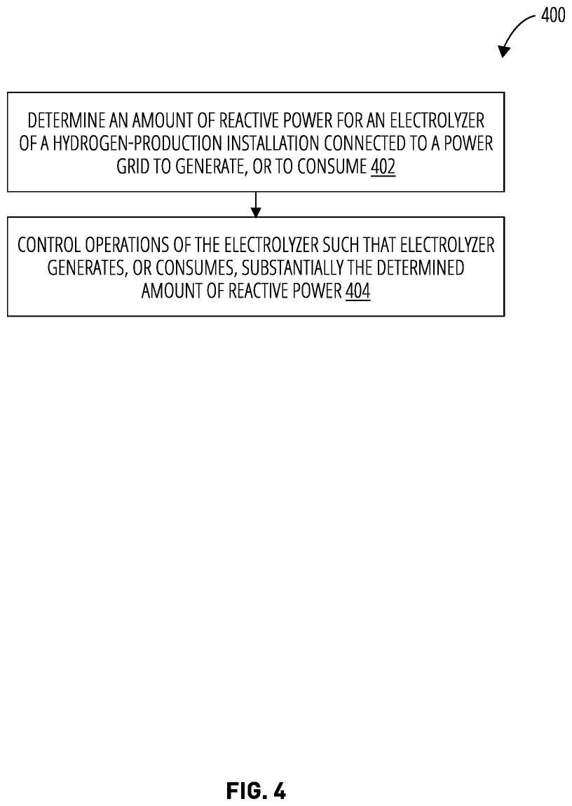

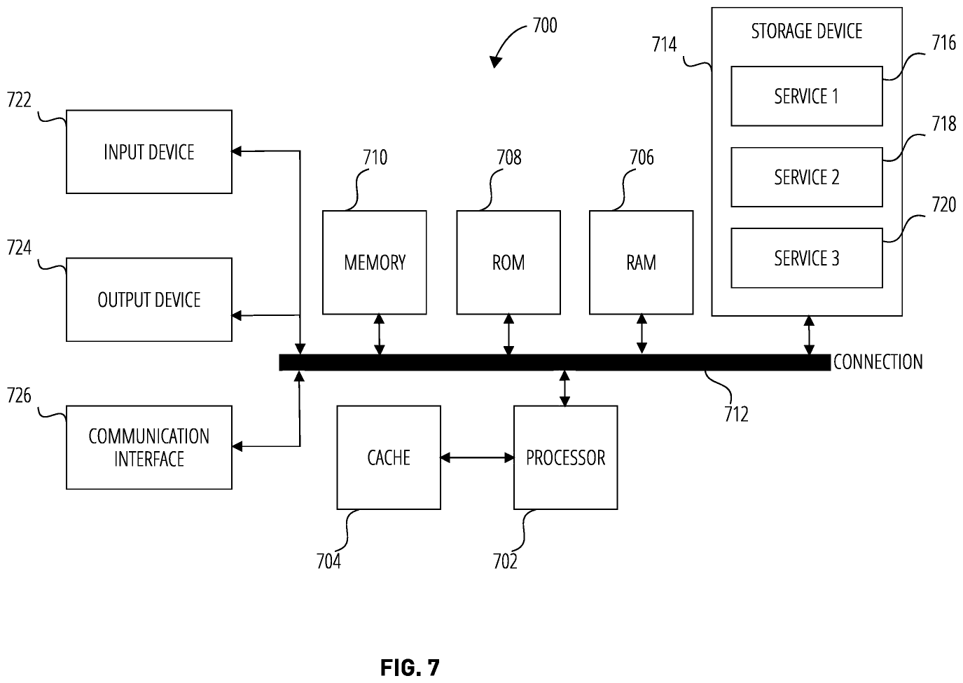

FIG. 4 illustrates an example of a process 400 for controlling hydrogen production based on reactive power. Process 400, or one or more operations thereof, may be performed by, or at, one or more elements of system 100 of FIG. 1, including, e.g., SCADA controller 108, plant controller 110, and/or electrolyzer 102, at one or more elements of electrolyzer 202, including, e.g., electrolyzer controller 204 and/or at power electronics 302 of FIG. 3. Additionally, or alternatively, process 400, or one or more operations thereof, may be performed by a computing device (or apparatus) or a component (e.g., a chipset, one or more processors, etc.) of the computing device. One or more of the operations of process 400 may be implemented as software components that are executed and run on one or more compute components or processors (e.g., processor 702 of FIG. 7, or other processor(s)).

At block 402, a computing device (or one or more components thereof) may determine an amount of reactive power for an electrolyzer of a hydrogen-production installation connected to a power grid to generate, or to consume. For example, SCADA controller 108 of FIG. 1 and/or plant controller 110 of FIG. 1 may determine the amount of reactive power for electrolyzers 102 of FIG. 1 to consume, or to generate (e.g., to balance reactive power of system 100 of FIG. 1). In some cases, SCADA controller 108 and/or plant controller 110 may balance reactive power of system 100 including energy sources 114 and/or loads 116.

At block 404, the computing device (or one or more components thereof) may control operations of the electrolyzer such that electrolyzer generates, or consumes, substantially the determined amount of reactive power. For example, SCADA controller 108 and/or plant controller 110 may control operations of electrolyzers 102 such that electrolyzers 102 consumes, or generates, the amount of reactive power determined at block 402.

In some embodiments, the computing device (or one or more components thereof) may control power electronics of the electrolyzer such that the power electronics generate, or consume, substantially the determined amount of reactive power. For example, SCADA controller 108 and/or plant controller 110 may generate signals 216 of FIG. 2 to control operations of power electronics 206 of FIG. 2. For example, in such embodiments, the computing device (or one or more components thereof) may control a plurality of pulse-width modulator rectifiers of the power electronics such that the plurality of pulse-width modulator rectifiers generates, or consumes, substantially the determined amount of reactive power. Additionally, or alternatively, in such embodiments the computing device (or one or more components thereof) may control one or more StatComs of the power electronics such that the StatComs generates, or consumes, substantially the determined amount of reactive power.

In some embodiments, the computing device (or one or more components thereof) may control or adjust hydrogen-production operations of the electrolyzer. For example, SCADA controller 108 and/or plant controller 110 may generate signals 216 to control operations of hydrogen-production stack 208 of FIG. 2. In some cases, the computing device (or one or more components thereof) may adjust hydrogen-production operations of the electrolyzer to increase a capability of the power electronics to generate, or consume, reactive power. Controlling or adjusting hydrogen-production operations of the electrolyzer may be, or may include, controlling a rate at which the electrolyzer produces hydrogen.

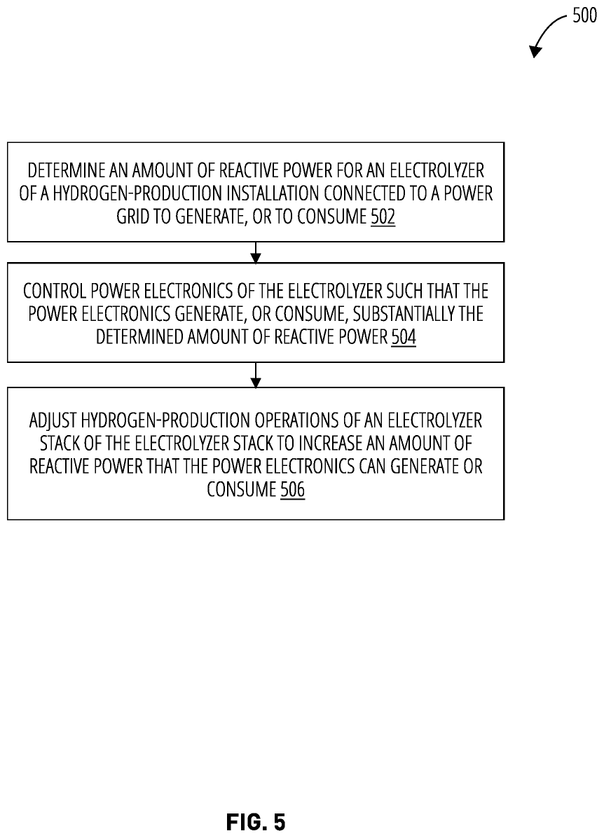

FIG. 5 illustrates an example of a process 500 for controlling hydrogen production based on reactive power. Process 500, or one or more operations thereof, may be performed by, or at, one or more elements of system 100 of FIG. 1, including, e.g., SCADA controller 108, plant controller 110, and/or electrolyzer 102, at one or more elements of electrolyzer 202, including, e.g., electrolyzer controller 204 and/or at power electronics 302 of FIG. 3. Additionally, or alternatively, process 500, or one or more operations thereof, may be performed by a computing device (or apparatus) or a component (e.g., a chipset, one or more processors, etc.) of the computing device. One or more of the operations of process 500 may be implemented as software components that are executed and run on one or more compute components or processors (e.g., processor 702 of FIG. 7, or other processor(s)).

At block 502, a computing device (or one or more components thereof) may determine an amount of reactive power for an electrolyzer of a hydrogen-production installation connected to a power grid to generate, or to consume. For example, SCADA controller 108 of FIG. 1 and/or plant controller 110 of FIG. 1 may determine the amount of reactive power for electrolyzers 102 of FIG. 1 to consume, or to generate (e.g., to balance reactive power of system 100 of FIG. 1). In some cases, SCADA controller 108 and/or plant controller 110 may balance reactive power of system 100 including energy sources 114 and/or loads 116.

At block 504, the computing device (or one or more components thereof) may control power electronics of the electrolyzer such that the power electronics generate, or consume, substantially the determined amount of reactive power. For example, SCADA controller 108 and/or plant controller 110 may generate signals 216 of FIG. 2 to control operations of power electronics 206 of FIG. 2.

At block 506, the computing device (or one or more components thereof) may adjust hydrogen-production operations of an electrolyzer stack of the electrolyzer stack to increase an amount of reactive power that the power electronics can generate or consume. For example, SCADA controller 108 and/or plant controller 110 may generate signals 216 to control operations of hydrogen-production stack 208 of FIG. 2.

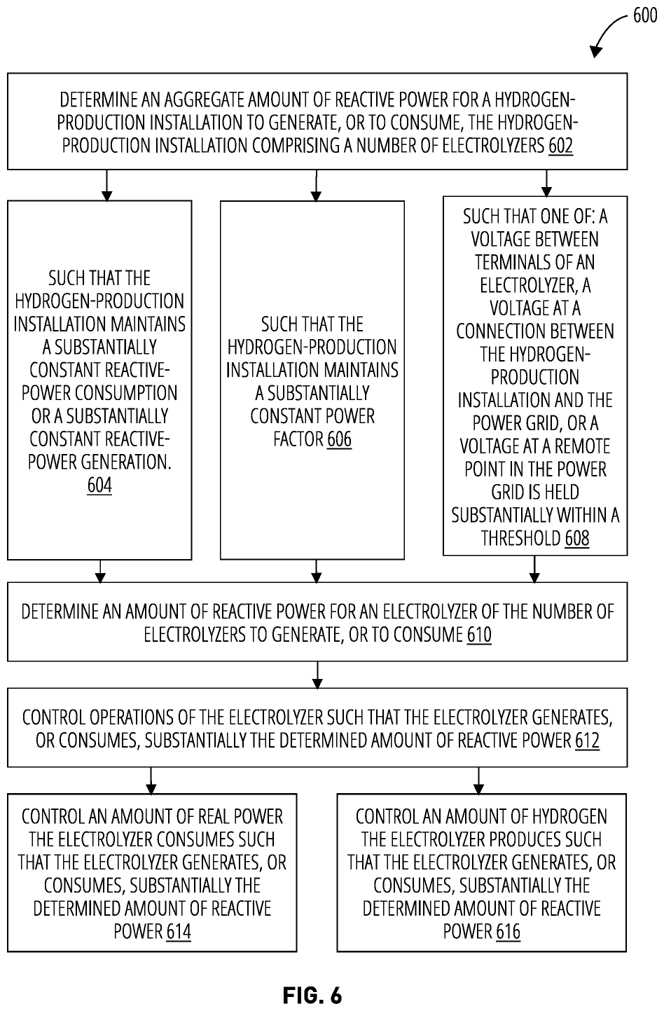

FIG. 6 illustrates an example of a process 600 for controlling hydrogen production based on reactive power. Process 600, or one or more operations thereof, may be performed by, or at, one or more elements of system 100 of FIG. 1, including, e.g., SCADA controller 108, plant controller 110, and/or electrolyzer 102, at one or more elements of electrolyzer 202, including, e.g., electrolyzer controller 204 and/or at power electronics 302 of FIG. 3. Additionally, or alternatively, process 600, or one or more operations thereof, may be performed by a computing device (or apparatus) or a component (e.g., a chipset, one or more processors, etc.) of the computing device. One or more of the operations of process 600 may be implemented as software components that are executed and run on one or more compute components or processors (e.g., processor 702 of FIG. 7, or other processor(s)).

At block 602, a computing device (or one or more components thereof) may determine an aggregate amount of reactive power for a hydrogen-production installation to generate, or to consume, the hydrogen-production installation comprising a number of electrolyzers. For example, SCADA controller 108 of FIG. 1 and/or plant controller 110 of FIG. 1 may determine the amount of reactive power for electrolyzers 102 of FIG. 1 to consume, or to generate (e.g., to balance reactive power of system 100 of FIG. 1). In some cases, SCADA controller 108 and/or plant controller 110 may balance reactive power of system 100 including energy sources 114 and/or loads 116.

Block 604, block 606, and block 608 may be alternative options. Each of block 604, block 606, and block 608 may affect the determination of block 602.

At block 604, the computing device (or one or more components thereof) may determine the aggregate amount of reactive power for the hydrogen-production installation to generate, or to consume, such that the hydrogen-production installation maintains a substantially constant reactive-power consumption or a substantially constant reactive-power generation.

At block 606, the computing device (or one or more components thereof) may determine the aggregate amount of reactive power for the hydrogen-production installation to generate, or to consume, such that the hydrogen-production installation maintains a substantially constant power factor.

At block 608, the computing device (or one or more components thereof) may determine the aggregate amount of reactive power for the hydrogen-production installation to generate, or to consume, such that one of: a voltage between terminals of an electrolyzer, a voltage at a connection between the hydrogen-production installation and the power grid, or a voltage at a remote point in the power grid is held substantially within a threshold.

As another alternative to block 604, block 606, and block 608, (not illustrated in FIG. 6), the computing device (or one or more components thereof) may determine the aggregate amount of reactive power for the hydrogen-production installation to generate, or to consume, such that a voltage between terminals of the electrolyzer, a voltage at a connection between the hydrogen-production installation and the power grid, or a voltage at a remote point in the power grid is held substantially within a threshold.

As another alternative to block 604, block 606, and block 608, (not illustrated in FIG. 6), the computing device (or one or more components thereof) may determine the aggregate amount of reactive power for the hydrogen-production installation to generate, or to consume, based on a power-factor threshold of the power grid.

As another alternative to block 604, block 606, and block 608, (not illustrated in FIG. 6), the computing device (or one or more components thereof) may determine the aggregate amount of reactive power for the hydrogen-production installation to generate, or to consume, based on reactive-power capability of one or more loads connected to the power grid.

At block 610, the computing device (or one or more components thereof) may determine an amount of reactive power for an electrolyzer of the number of electrolyzers to generate, or to consume. For example, the computing device (or one or more components thereof) may determine a respective amount of reactive power for each electrolyzer of a plurality of electrolyzers of the hydrogen-production installation to consume or to generate.

At block 612, the computing device (or one or more components thereof) may control operations of the electrolyzer such that the electrolyzer generates, or consumes, substantially the determined amount of reactive power. For example, the computing device (or one or more components thereof) may control respective operations of each of the plurality of electrolyzers such that the plurality of electrolyzers collectively consume, or generate, the amount of reactive power determined at block 602.

Block 614 and block 616 may be alternative options. Each of block 614 and block 616 may affect the control of block 612.

At block 614, the computing device (or one or more components thereof) may control an amount of real power the electrolyzer consumes such that the electrolyzer generates, or consumes, substantially the determined amount of reactive power.

At block 616, the computing device (or one or more components thereof) may control an amount of hydrogen the electrolyzer produces such that the electrolyzer generates, or consumes, substantially the determined amount of reactive power.

In some examples, the methods described herein (e.g., process 400 of FIG. 4, process 500 of FIG. 5, process 600 of FIG. 6 and/or other methods described herein) can be performed by a computing device or apparatus. In one example, one or more of the methods can be performed by system 100 of FIG. 1, SCADA controller 108 of FIG. 1, plant controller 110 of FIG. 1, and/or electrolyzer controller 204 of FIG. 2. In another example, one or more of the methods can be performed by one or more elements of computing-device architecture 700 shown in FIG. 7. For instance, a computing device with computing-device architecture 700 shown in FIG. 7 can include the components of the system 100, and/or electrolyzer 202, and can implement the operations of the process 400, process 500, process 600 of FIG. 6 and/or other process described herein.

The computing device can include any suitable device, a desktop computer, a server computer, and/or any other computing device with the resource capabilities to perform the processes described herein, including process 400, process 500, process 600 and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 500, process 600 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 500, process 600 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 7 illustrates an example computing-device architecture 700 of an example computing device which can implement the various techniques described herein. In some examples, the computing device can include a personal computer, a laptop computer, a server computer, or other device. The components of computing-device architecture 700 are shown in electrical communication with each other using connection 712, such as a bus. The example computing-device architecture 700 includes a processing unit (CPU or processor) 702 and computing device connection 712 that couples various computing device components including computing device memory 710, such as read only memory (ROM) 708 and random-access memory (RAM) 706, to processor 702.

Computing-device architecture 700 can include a cache of high-speed memory connected directly with, in close proximity to, or integrated as part of processor 702. Computing-device architecture 700 can copy data from memory 710 and/or the storage device 714 to cache 704 for quick access by processor 702. In this way, the cache can provide a performance boost that avoids processor 702 delays while waiting for data. These and other modules can control or be configured to control processor 702 to perform various actions. Other computing device memory 710 may be available for use as well. Memory 710 can include multiple different types of memory with different performance characteristics. Processor 702 can include any general-purpose processor and a hardware or software service, such as service 1 716, service 2 718, and service 3 720 stored in storage device 714, configured to control processor 702 as well as a special-purpose processor where software instructions are incorporated into the processor design. Processor 702 may be a self-contained system, containing multiple cores or processors, a bus, memory controller, cache, etc. A multi-core processor may be symmetric or asymmetric.

To enable user interaction with the computing-device architecture 700, input device 722 can represent any number of input mechanisms, such as a microphone for speech, a touch-sensitive screen for gesture or graphical input, keyboard, mouse, motion input, speech and so forth. Output device 724 can also be one or more of a number of output mechanisms known to those of skill in the art, such as a display, projector, television, speaker device, etc. In some instances, multimodal computing devices can enable a user to provide multiple types of input to communicate with computing-device architecture 700. Communication interface 726 can generally govern and manage the user input and computing device output. There is no restriction on operating on any particular hardware arrangement and therefore the basic features here may easily be substituted for improved hardware or firmware arrangements as they are developed.

Storage device 714 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 706, read only memory (ROM) 708, and hybrids thereof. Storage device 714 can include services 716, 718, and 720 for controlling processor 702. Other hardware or software modules are contemplated. Storage device 714 can be connected to the computing device connection 712. In one embodiment, a hardware module that performs a particular function can include the software component stored in a computer-readable medium in connection with the necessary hardware components, such as processor 702, connection 712, output device 724, and so forth, to carry out the function.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, embodiments of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and embodiments of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “connected to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative embodiments of the disclosure include:

Embodiment 1. A method for producing hydrogen, the method comprising: determining an amount of reactive power for an electrolyzer of a hydrogen-production installation connected to a power grid to generate, or to consume; and controlling operations of the electrolyzer such that electrolyzer generates, or consumes, substantially the determined amount of reactive power.

Embodiment 2. The method of embodiment 1, wherein controlling operations of the electrolyzer comprises controlling power electronics of the electrolyzer such that the power electronics generate, or consume, substantially the determined amount of reactive power.

Embodiment 3. The method of embodiment 2, wherein controlling the power electronics of the electrolyzer comprises controlling a plurality of pulse-width modulator rectifiers of the power electronics such that the power electronics generate, or consume, substantially the determined amount of reactive power.

Embodiment 4. The method of any one of embodiment 2 or 3, wherein controlling operations of the electrolyzer further comprises adjusting hydrogen-production operations of the electrolyzer.

Embodiment 5. The method of embodiment 1, wherein controlling operations of the electrolyzer comprises controlling hydrogen-production operations of the electrolyzer.

Embodiment 6. The method of embodiment 4, wherein controlling hydrogen-production operations of the electrolyzer comprises controlling a rate at which the electrolyzer produces hydrogen.

Embodiment 7. The method of any one of embodiment 1 to 6, further comprising: determining an aggregate amount of reactive power for the hydrogen-production installation to generate, or to consume, the hydrogen-production installation comprising a number of electrolyzers including the electrolyzer; determining a respective amount of reactive power for each electrolyzer of the number of electrolyzers to generate, or to consume; and controlling respective operations of each electrolyzer of the number of electrolyzers such that the hydrogen-production installation generates, or consumes, substantially the aggregate amount of reactive power.

Embodiment 8. The method of embodiment 7, wherein the aggregate amount of reactive power to generate, or to consume, is determined such that the hydrogen-production installation maintains a substantially constant reactive-power consumption or a substantially constant reactive-power generation.

Embodiment 9. The method of any one of embodiment 7 or 8, wherein the aggregate amount of reactive power to generate, or to consume, is determined such that the hydrogen-production installation maintains a substantially constant power factor.

Embodiment 10. The method of any one of embodiment 7 or 9, wherein the aggregate amount of reactive power to generate, or to consume, is determined such that one of: a voltage between terminals of the electrolyzer, a voltage at a connection between the hydrogen-production installation and the power grid, or a voltage at a remote point in the power grid is held substantially within a threshold.

Embodiment 11. The method of any one of embodiment 1 to 10, wherein the amount of reactive power to generate, or to consume, is determined based on a power-factor threshold of the power grid.

Embodiment 12. The method of any one of embodiment 1 to 11, wherein controlling operations of the electrolyzer comprises controlling an amount of real power the electrolyzer consumes such that the electrolyzer generates, or consumes, substantially the determined amount of reactive power.

Embodiment 13. The method of any one of embodiment 1 to 12, wherein the amount of reactive power to generate, or to consume, is determined based on reactive-power capability of one or more power sources connected to the power grid.

Embodiment 14. The method of any one of embodiment 1 to 13, wherein the amount of reactive power to generate, or to consume, is determined based on reactive-power capability of one or more loads connected to the power grid.

Embodiment 15. A system for producing hydrogen, the system comprising: a connection to a power grid configured to receive electrical power from the power grid; one or more electrolyzers configured to receive the electrical power and to produce hydrogen; and a controller configured to: determine an amount of reactive power for the one or more electrolyzers to generate, or to consume; and control respective operations of the one or more electrolyzers such that the one or more electrolyzers collectively generate, or consume, substantially the determined amount of reactive power.

Embodiment 16. The system of embodiment 15, wherein the controller is further configured to determine the amount of reactive power to generate, or to consume, such that the system is balanced.

Embodiment 17. The system of any one of embodiment 15 or 16, wherein: the system further comprises one or more loads; and the controller is further configured to determine the amount of reactive power to generate, or to consume, such that the system is balanced.

Embodiment 18. The system of any one of embodiment 15 to 17, wherein: the system further comprises one or more energy sources; and the controller is further configured to determine the amount of reactive power to generate, or to consume, such that the system is balanced.

Embodiment 19. The system of any one of embodiment 15 to 18, wherein: the system further comprises one or more loads and one or more energy sources; and the controller is further configured to determine the amount of reactive power to generate, or to consume, such that the system is balanced.

Embodiment 20. An electrolyzer for producing hydrogen, the electrolyzer comprising: a hydrogen-production stack configured to receive direct current (DC) power and water to produce hydrogen; power electronics configured to receive alternating current (AC) power, convert the AC power into the DC power, and to provide the DC power to the hydrogen-production stack; and a controller configured to receive a control signal and to control operations of the electrolyzer such that the electrolyzer generates, or consumes, reactive power according to instructions of the control signal.

Embodiment 21. The electrolyzer of embodiment 20, wherein the controller is configured to control the power electronics such that the power electronics generate, or consume, reactive power according to instructions of the control signal.

Embodiment 22. The electrolyzer of embodiment 21, wherein the power electronics comprise a plurality of pulse-width modulator rectifiers and wherein the controller is configured to control operations of the plurality of pulse-width modulator rectifiers such that the plurality of pulse-width modulator rectifiers generate, or consume, substantially the determined amount of reactive power.

Embodiment 23. The electrolyzer of embodiment 21, wherein the controller is further configured to control hydrogen-production operations of the hydrogen-production stack.

Embodiment 24. The electrolyzer of embodiment 21, wherein the controller is further configured to control hydrogen-production operations of the hydrogen-production stack to increase an amount of reactive power that the power electronics can generate or consume.

Embodiment 25. The electrolyzer of embodiment 20, the controller is configured to control hydrogen-production operations of the hydrogen-production stack.

Embodiment 26. The electrolyzer of any one of embodiment 20 to 25, further comprising: a cooling system; a hydrogen-purification system; a water-purification system; and an uninterruptible power supply.

Embodiment 27. The method of embodiment 2, wherein controlling the power electronics of the electrolyzer comprises controlling one or more static synchronous compensators (Statcoms) such that the one or more StatComs generate, or consume, substantially the determined amount of reactive power.

Embodiment 28. The method of embodiment 2, wherein controlling the power electronics of the electrolyzer comprises controlling one or more static synchronous compensators (Statcoms) and a plurality of pulse-width modulator rectifiers such that the one or more StatComs generate, or consume, substantially the determined amount of reactive power.

Embodiment 29. The method of embodiment 2, wherein controlling operations of the electrolyzer further comprises adjusting hydrogen-production operations of the electrolyzer to increase an amount of reactive power that the power electronics can generate or consume.

What is claimed is:

1. A method for producing hydrogen, the method comprising:
determining an amount of reactive power for an electrolyzer of a hydrogen-production installation connected to a power grid to generate, or to consume; and
controlling operations of the electrolyzer such that electrolyzer generates, or consumes, substantially the determined amount of reactive power.

2. The method of claim 1, wherein controlling the operations of the electrolyzer comprises controlling a plurality of pulse-width modulator rectifiers of power electronics of the electrolyzer such that the power electronics generate, or consume, substantially the determined amount of reactive power.

3. The method of claim 1, wherein controlling the operations of the electrolyzer comprises controlling one or more static synchronous compensators (Statcoms) of the electrolyzer such that the one or more StatComs generate, or consume, substantially the determined amount of reactive power.

4. The method of claim 2, wherein controlling operations of the electrolyzer further comprises adjusting hydrogen-production operations of the electrolyzer to increase an amount of reactive power that the power electronics can generate or consume.

5. The method of claim 1, further comprising:
determining an aggregate amount of reactive power for the hydrogen-production installation to generate, or to consume, the hydrogen-production installation comprising a number of electrolyzers including the electrolyzer;
determining a respective amount of reactive power for each electrolyzer of the number of electrolyzers to generate, or to consume; and
controlling respective operations of each electrolyzer of the number of electrolyzers such that the hydrogen-production installation generates, or consumes, substantially the aggregate amount of reactive power.

6. The method of claim 5, wherein the aggregate amount of reactive power to generate, or to consume, is determined such that the hydrogen-production installation maintains a substantially constant reactive-power consumption or a substantially constant reactive-power generation.

7. The method of claim 5, wherein the aggregate amount of reactive power to generate, or to consume, is determined such that the hydrogen-production installation maintains a substantially constant power factor.

8. The method of claim 5, wherein the aggregate amount of reactive power to generate, or to consume, is determined such that one of: a voltage between terminals of the electrolyzer, a voltage at a connection between the hydrogen-production installation and the power grid, or a voltage at a remote point in the power grid is held substantially within a threshold.

9. The method of claim 1, wherein the amount of reactive power to generate, or to consume, is determined based on a power-factor threshold of the power grid.

10. The method of claim 1, wherein controlling operations of the electrolyzer comprises controlling an amount of real power the electrolyzer consumes such that the electrolyzer generates, or consumes, substantially the determined amount of reactive power.

11. The method of claim 1, wherein the amount of reactive power to generate, or to consume, is determined based on reactive-power capability of one or more power sources connected to the power grid.

12. The method of claim 1, wherein the amount of reactive power to generate, or to consume, is determined based on reactive-power capability of one or more loads connected to the power grid.

13. A system for producing hydrogen, the system comprising:
a connection to a power grid configured to receive electrical power from the power grid;
one or more electrolyzers configured to receive the electrical power and to produce hydrogen; and
a controller configured to:
determine an amount of reactive power for the one or more electrolyzers to generate, or to consume; and
control respective operations of the one or more electrolyzers such that the one or more electrolyzers collectively generate, or consume, substantially the determined amount of reactive power.

14. The system of claim 13, wherein the controller is further configured to determine the amount of reactive power to generate, or to consume, such that the system is balanced.

15. The system of claim 13, wherein:
the system further comprises one or more loads; and
the controller is further configured to determine the amount of reactive power to generate, or to consume, such that the system is balanced.

16. The system of claim 13, wherein:
the system further comprises one or more energy sources; and
the controller is further configured to determine the amount of reactive power to generate, or to consume, such that the system is balanced.

17. An electrolyzer for producing hydrogen, the electrolyzer comprising:
a hydrogen-production stack configured to receive direct current (DC) power and water to produce hydrogen;
power electronics configured to receive alternating current (AC) power, convert the AC power into the DC power, and to provide the DC power to the hydrogen-production stack; and
a controller configured to receive a control signal and to control operations of the electrolyzer such that the electrolyzer generates, or consumes, reactive power according to instructions of the control signal.

18. The electrolyzer of claim 17, wherein the controller is configured to control the power electronics such that the power electronics generate, or consume, reactive power according to instructions of the control signal.

19. The electrolyzer of claim 18, wherein the power electronics comprise a plurality of pulse-width modulator rectifiers and wherein the controller is configured to control operations of the plurality of pulse-width modulator rectifiers such that the power electronics generate, or consume, reactive power according to instructions of the control signal.

20. The electrolyzer of claim 18, wherein the controller is further configured to control hydrogen-production operations of the hydrogen-production stack to increase an amount of reactive power that the power electronics can generate or consume.
